(19) United States
(12) Patent Application Publication
(10) Pub. No.: US 2026/0035040 A1
(43) Pub. Date: Feb. 5, 2026

(54) VEHICLE COWL STRUCTURE

(71) Applicants: Hyundai Motor Company, Seoul (KR); Kia Corporation, Seoul (KR)

(72) Inventor: Song-Jae Jeong, Hwaseong-si (KR)

(21) Appl. No.: 19/175,164

(22) Filed: Apr. 10, 2025

(30) Foreign Application Priority Data
Aug. 5, 2024 (KR) 10-2024-0103950

(51) Int. Cl. B62D 25/08; B60H 1/28

(52) U.S. Cl. CPC B62D 25/081; B60H 1/28

(57) ABSTRACT

A vehicle cowl structure can include a cowl lower panel extending in a width direction of a vehicle, and a guide panel having an outer end coupled to an inner end of the cowl lower panel in a configuration so that outside air can be introduced into an air conditioning device of the vehicle, wherein the outer end of the guide panel is positioned to be higher than the inner end of the cowl lower panel, such that a gap is defined between the inner end of the cowl lower panel and the outer end of the guide panel.

### CROSS-REFERENCE TO RELATED APPLICATIONS

This application claims priority to Korean Patent Application No. 10-2024-0103950, filed on Aug. 5, 2024, which is incorporated herein by reference in its entirety.

### TECHNICAL FIELD

The present disclosure relates to a vehicle cowl structure.

### BACKGROUND

A cowl, which connects left and right front pillars of a vehicle, is an important constituent element that reduces torsion of a vehicle body and contributes to improving lateral bending rigidity.

The cowl also serves to support a windshield glass, a wiper, a steering column, and the like.

In particular, the cowl discharges moisture from the windshield glass to the outside, and outside air is introduced into a vehicle interior through the cowl.

Referring to FIGS. 1 and 2, a cowl includes a cowl lower panel 110 configured to connect lower ends of front pillar panels 145, and a cowl top panel 142 positioned above the cowl lower panel 110. The cowl lower panel 110 and the cowl top panel 142 are coupled to define a structure, together with a cowl cross member 141, to contribute to torsional properties and lateral bending rigidity.

Water drain holes 114 are formed at two opposite ends of the cowl lower panel 110 to discharge moisture from the cowl lower panel 110 to a lower side of the vehicle, and a through-hole is formed in the cowl lower panel 110 to introduce outside air into an air conditioning device 150.

Among the vehicles, an electric vehicle requires devices related to a heater for heating the vehicle, which increases a volume of the air conditioning device 150. Therefore, the air conditioning device 150 penetrates a dash panel 147 of the vehicle and is installed in the vehicle interior and an engine room.

To introduce the outside air into the air conditioning device 150, an air intake port 131 is formed to penetrate the cowl lower panel 110.

Typically, the moisture, which has fallen onto the periphery of the windshield glass during rainfall or a vehicle washing process, moves to a lower end of the windshield glass along a surface of the windshield glass or passes over a cowl top cover 143 and drains to the lower side of the vehicle through the cowl lower panel 110.

Because the air intake port 131 is formed in the cowl lower panel 110, the moisture is likely to be introduced from the outside. Therefore, a guide panel 130 having a reverse flow prevention wall 132 is provided along a periphery of the air intake port 131.

When a flow of air is introduced into the air conditioning device 150 through the air intake port 131 as the air conditioning device 150 operates, there occurs a problem in that the moisture introduced into the cowl lower panel 110 through the cowl top cover 143 is introduced into the vehicle interior even though the reverse flow prevention wall 132 is formed. When the air conditioning device 150 operates, the moisture in the form of water droplets moves to the air intake port 131 (see FIG. 2) without moving to the water drain hole 114 along the cowl lower panel 110 and is introduced into the vehicle interior through the air conditioning device 150. The moisture introduced in the form of mist is also introduced into the air conditioning device 150 together with the flow of air between the cowl top panel 142 and the cowl lower panel 110.

Because NVH (noise, vibration, harshness) performance is degraded by the air intake port 131, a cowl support bracket 120 is installed adjacent to the air intake port 131. The configuration in which the cowl support bracket 120 is installed so that lower and upper ends of the cowl support bracket 120 respectively adjoin the cowl lower panel 110 and the cowl top panel 142 is provided merely to improve the NVH performance. However, this configuration cannot prevent the introduction of moisture.

### SUMMARY

The present disclosure relates to a vehicle cowl structure with improved water-tightness, and a vehicle cowl structure of an embodiment of the present disclosure can be capable of preventing moisture from being introduced into a vehicle interior from the outside.

Various embodiments of the present disclosure can provide a vehicle cowl structure with improved water-tightness, and the vehicle cowl structure can be capable of preventing moisture from being introduced into an air conditioning device by suppressing a movement of the moisture or discharging the moisture to the outside even though the moisture is moved along a cowl lower panel during an operation of an air conditioning device.

For a vehicle cowl structure with improved water-tightness according to an example embodiment of the present disclosure, the vehicle cowl structure may include: a cowl lower panel formed in a width direction of a vehicle; and a guide panel having an outer end coupled to an inner end of the cowl lower panel so that outside air can be introduced into an air conditioning device of the vehicle, and in which the outer end of the guide panel is positioned to be higher than the inner end of the cowl lower panel, such that a gap is defined between the inner end of the cowl lower panel and the outer end of the guide panel.

The cowl lower panel and the guide panel may overlap each other by a first length (e.g., selected or predetermined) in the width direction of the vehicle.

The cowl lower panel may include: a panel portion formed in the width direction of the vehicle; a front flange portion disposed to be higher than the panel portion and formed at a front end of the panel portion along the panel portion; and a rear flange portion formed at a rear end of the panel portion and bent upward from the panel portion.

The panel portion may be positioned to be lower than the guide panel while having a gap with the outer end of the guide panel.

An air intake port, through which the air introduced from the outside can pass, may be formed in the guide panel, and a reverse flow prevention wall having a first height (e.g., selected or predetermined) may be formed along a periphery of the air intake port.

The vehicle cowl structure may further include: a cowl support bracket having a dual wall structure formed at a portion joined to the cowl lower panel and the guide panel, the cowl support bracket having slots.

The cowl support bracket may include: an inner panel portion having an inner slot and having a lower end coupled to the guide panel; an outer panel portion having an outer slot and having a lower end coupled to the cowl lower panel; and a connection portion configured to connect the inner panel portion and the outer panel portion.

The inner slot and the outer slot may be inclined by selected or predetermined angles and formed to be directed in different directions.

The inner slot may be provided as a plurality of inner slots formed in the inner panel portion and/or formed in parallel with one another, and the outer slot may be provided as a plurality of outer slots formed in the outer panel portion and/or formed in parallel with one another.

An upper flange portion coupled to a cowl top panel may be formed at an upper end of the inner panel portion, and a lower flange portion coupled to the guide panel may be formed at a lower end of the inner panel portion.

An upper flange portion coupled to a cowl top panel may be formed at an upper end of the outer panel portion, and a lower flange portion coupled to the cowl lower panel may be formed at a lower end of the outer panel portion.

A panel portion of the cowl lower panel may be stepped so that the panel portion on an inner side of the vehicle is configured to be higher than the panel portion on an outer side of the vehicle.

A downward bent portion bent downward may be formed at an end of an upper panel portion positioned at an upper side of the panel portion, an upward bent portion may be formed at an end of a lower panel portion positioned at a lower side of the panel portion, and a through-hole may be formed between the downward bent portion and the upward bent portion.

The upward bent portion and the downward bent portion may be inclined by a selected or predetermined angle with respect to a line perpendicular to a ground surface.

According to an embodiment of the present disclosure, the vehicle cowl structure with improved water-tightness can be configured as described above, and the moisture can be discharged to the outside while moving even though the moisture in the cowl is moved to the air conditioning device by the operation of the air conditioning device.

Therefore, using an embodiment of the present disclosure, it can be possible to prevent the moisture, which is introduced during rainfall or a vehicle washing process, from being introduced into the vehicle interior.

### BRIEF DESCRIPTION OF THE DRAWINGS

FIG. 1 is a perspective view illustrating a vehicle cowl structure in the related art.

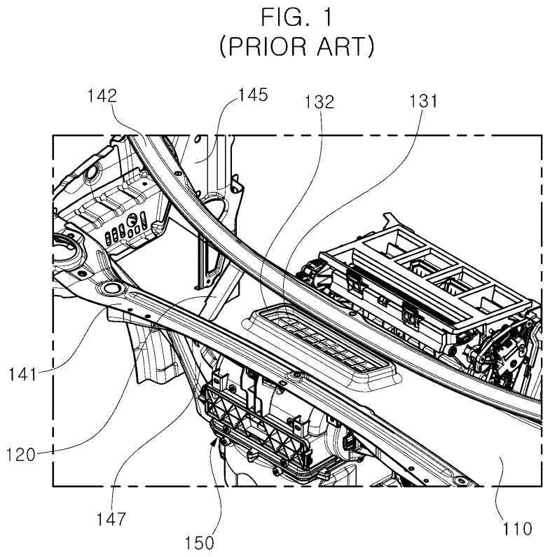

FIG. 2 is a cross-sectional view illustrating a state in which moisture is introduced into an air conditioning device by the vehicle cowl structure in the related art.

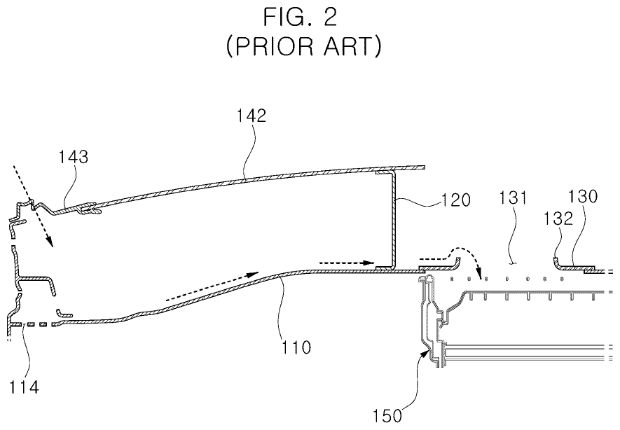

FIG. 3 is a perspective view illustrating a part to which a vehicle cowl structure with improved water-tightness according to an embodiment of the present disclosure is applied.

FIG. 4 is a perspective view illustrating a vehicle cowl structure with improved water-tightness according to an embodiment of the present disclosure.

FIG. 5 is a cross-sectional view taken along line I-I in FIG. 3.

FIG. 6 is a cross-sectional view taken along line II-II in FIG. 3.

FIG. 7A is an exploded perspective view illustrating a coupling relationship between a cowl lower panel and a guide panel of a vehicle cowl structure with improved water-tightness according to an embodiment of the present disclosure.

FIG. 7B is a side view illustrating a state in which a cowl lower panel and a guide panel of a vehicle cowl structure with improved water-tightness according to an embodiment of the present disclosure are coupled.

FIG. 8A is a perspective view illustrating a cowl support bracket of a vehicle cowl structure with improved water-tightness according to an embodiment of the present disclosure.

FIG. 8B is a perspective view illustrating a cowl support bracket of a vehicle cowl structure with improved water-tightness according to an embodiment of the present disclosure when viewed in another direction.

FIG. 8C is a side view illustrating a cowl support bracket of a vehicle cowl structure with improved water-tightness according to an embodiment of the present disclosure.

FIG. 9 is a perspective view illustrating a state in which moisture is discharged through a part indicated by C in FIG. 5, according to an embodiment of the present disclosure.

FIG. 10 is a perspective view illustrating a state in which moisture is discharged from a vehicle cowl structure with improved water-tightness according to an embodiment of the present disclosure.

FIG. 11 is a cross-sectional view illustrating a cowl lower panel of a vehicle cowl structure with improved water-tightness according to an embodiment of the present disclosure.

### DETAILED DESCRIPTION OF ILLUSTRATIVE EMBODIMENTS

Hereinafter, example embodiments of the present disclosure will be described in detail with reference to the example accompanying drawings, and because these embodiments, as examples, may be implemented in various different forms by those skilled in the art to which the present disclosure pertains, the present disclosure is not necessarily limited to the example embodiments described herein.

Hereinafter, vehicle cowl structures with improved water-tightness according to example embodiments of the present disclosure will be described in detail with reference to the accompanying drawings.

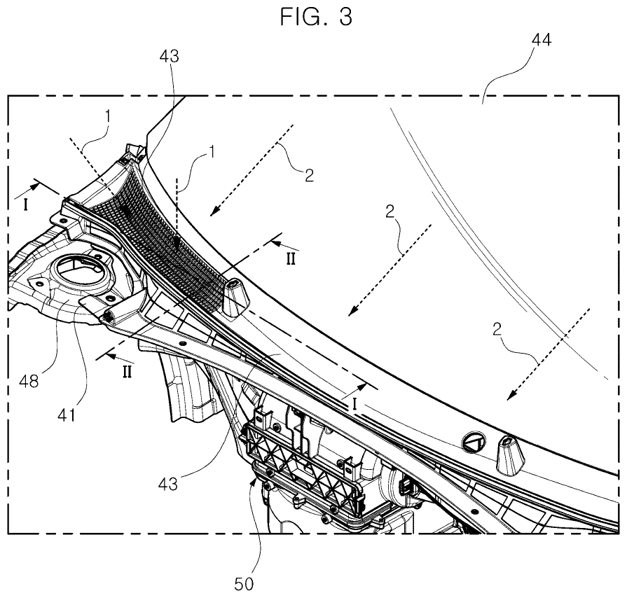

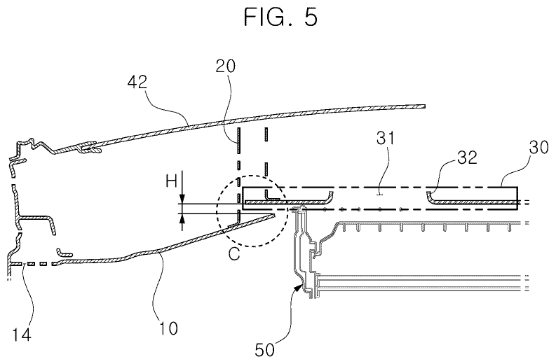

Referring to FIGS. 3-11, a vehicle cowl structure with improved water-tightness according to an embodiment of the present disclosure can include a cowl lower panel 10 in a width direction of a vehicle, and a guide panel 30 having an outer end coupled to an inner end of the cowl lower panel 10 so that outside air can be introduced into an air conditioning device 50 of the vehicle. The outer end of the guide panel 30 can be positioned to be higher than the inner end of the cowl lower panel 10, such that a gap H (see, e.g., FIG. 5) is defined between the inner end of the cowl lower panel 10 and the outer end of the guide panel 30.

The cowl lower panel 10 can be formed to have a first length (e.g., selected or predetermined) in the width direction of the vehicle. An outer end of the cowl lower panel 10 can be coupled to a front pillar panel 45 of the vehicle. A cowl side inner upper panel 46 may be provided to connect the cowl lower panel 10 and the front pillar panel 45.

A front end of a windshield glass 44 of the vehicle can be supported by the cowl lower panel 10 and the cowl top panel 42.

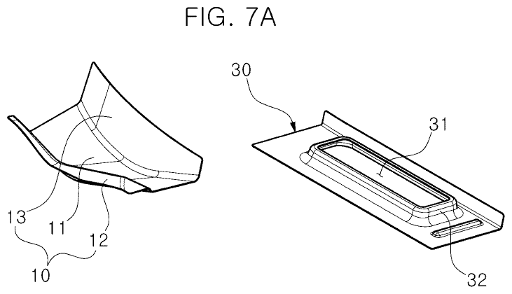

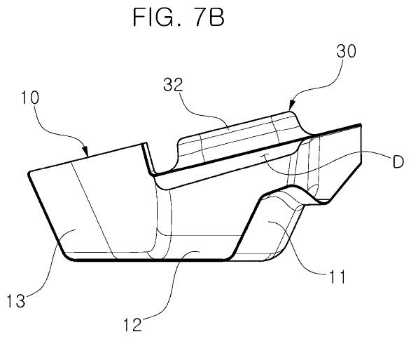

The cowl lower panel 10 can include a panel portion 11 formed in the width direction of the vehicle, a front flange portion 12 provided at a front side of the panel portion 11, and a rear flange portion 13 formed at a rear side of the panel portion 11 (see, e.g., FIGS. 7A and 7B).

The panel portion 11 can have a panel shape, such that the panel portion 11 forms a part of the cowl lower panel 10. To drain the moisture, the panel portion 11 can be formed to be lowered to an outer end thereof, i.e., an end positioned outward based on the width direction of the vehicle.

A water drain hole 14 can be formed at a portion of the cowl lower panel 10 adjacent to the outer end, i.e., the outer end of the panel portion 11 to discharge the moisture from an upper surface of the cowl lower panel 10 to the lower side of the vehicle (see, e.g., FIG. 5).

The front flange portion 12 can be disposed to be higher than the panel portion 11 and formed at a front end of the panel portion 11 along the panel portion 11. The cowl lower panel 10 may be coupled to the cowl top panel 42 by use of the front flange portion 12.

The rear flange portion 13 can be formed at a rear end of the panel portion 11 and bent upward from the panel portion 11.

The cowl lower panel 10 can be coupled to a cowl top cover 43 by use of a front end of the cowl lower panel 10, i.e., the front flange portion 12, for example.

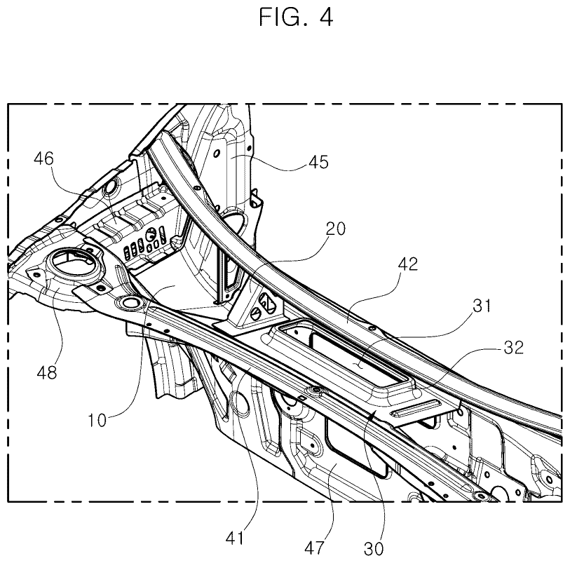

As illustrated in FIG. 4, a cowl top panel 42 can be coupled to an upper portion of the cowl lower panel 10 and define a structure, thereby contributing to torsional properties and lateral bending rigidity of the vehicle. As illustrated in FIG. 4, a cowl cross member 41, which can connect a fender apron panel 48, also can improve torsional properties and lateral bending rigidity together with the cowl lower panel 10 and the cowl top panel 42.

A rear end of the cowl lower panel 10 may be coupled to a dash panel 47 by use of the rear flange portion 13. The air conditioning device 50 is mounted while penetrating the dash panel 47. A vehicle of an embodiment of the present disclosure may be an electric vehicle having no combustion engine. A vehicle equipped with a combustion engine may use a coolant, which can have a temperature raised by cooling the engine, as a heat source for heating the vehicle interior. However, because an electric vehicle can need to be equipped with a heater capable of heating air to be supplied to the vehicle interior, a volume of the air conditioning device 50 can be increased. Therefore, the air conditioning device can be mounted to penetrate the dash panel 47.

The guide panel 30 can be positioned inward of the cowl lower panel 10 based on a given vehicle. The outer end of the guide panel 30 can be coupled to the inner end of the cowl lower panel 10. An air intake port 31 can be formed in the guide panel 30 to introduce outside air into the air conditioning device 50 of the vehicle from the outside.

The outer end of the guide panel 30 can be formed to overlap the inner end of the cowl lower panel 10 by a first length (e.g., selected or predetermined) in the width direction of the vehicle, such that the outer end of the guide panel 30 can be positioned to be higher than the inner end of the cowl lower panel 10.

Because the panel portion 11 of the cowl lower panel 10 can be formed to be lower than the front flange portion 12, the panel portion 11 can be positioned to be lower than the outer end of the guide panel 30. Therefore, as illustrated in FIG. 5, the inner end of the cowl lower panel 10 and the outer end of the guide panel 30 can overlap each other, and a gap H can be defined by a height difference. The moisture can be discharged from the cowl lower panel 10 through the gap H defined between the inner end of the cowl lower panel 10 and the outer end of the guide panel 30 without moving to the air intake port 31 formed in the guide panel 30.

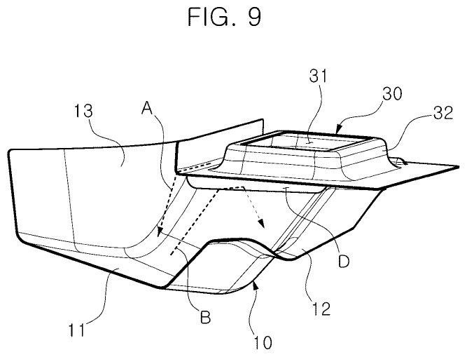

Because the gap H can be defined between the guide panel 30 and the cowl lower panel 10 as the guide panel 30 can be positioned to be higher than the cowl lower panel 10, the moisture may drain normally as indicated by the arrow A in FIG. 9. Even if the moisture is moved together with the air by the operation of the air conditioning device 50, the moisture can be discharged to the lower side of vehicle through the gap H between the guide panel 30 and the cowl lower panel 10, as indicated by the arrow B in FIG. 9, for example.

A reverse flow prevention wall 32 having a first height (e.g., selected or predetermined) can be formed along a periphery of the air intake port 31 to allow the air, which is introduced from the outside, to pass through the guide panel 30 and be introduced into the air conditioning device 50, which can prevent the moisture from being introduced into the air conditioning device 50.

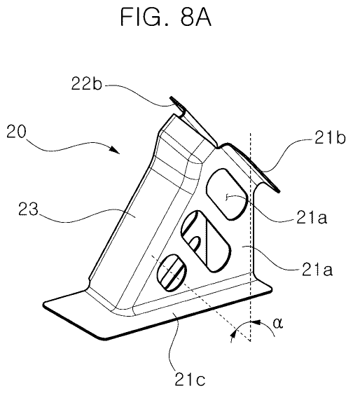

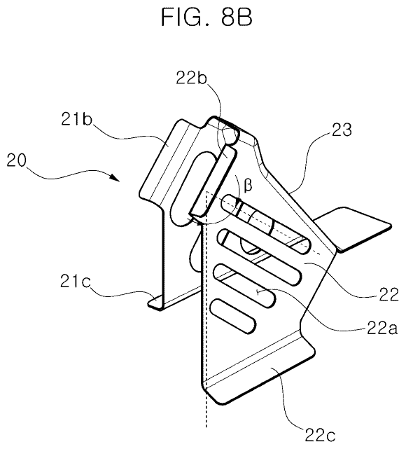

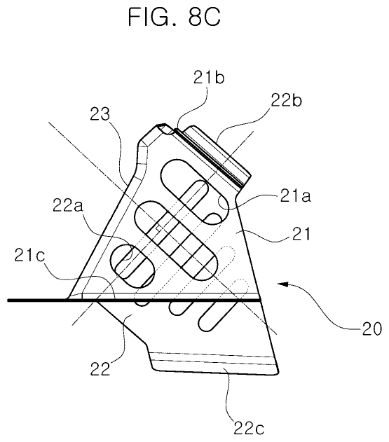

Referring to FIGS. 4 and 8A-8C, a cowl support bracket 20 can have a dual wall structure formed at a portion joined to the cowl lower panel 10 and the guide panel 30 and can have slots 21a and 22a. The air can pass through the cowl support bracket 20 and can be introduced into the air conditioning device, and the moisture can flow downward along the cowl support bracket 20 and drain without easily passing through the slots 21a and 22a.

A specific shape of the cowl support bracket 20 of an example embodiment will be described. The cowl support bracket 20 can include an inner panel portion 21 having a lower end coupled to the guide panel 30 and having inner slots 21a, and an outer panel portion 22 having a lower end coupled to the cowl lower panel 10 and having outer slots 22a.

The inner panel portion 21 can be formed as a surface perpendicular to the width direction of the vehicle. An upper and lower flange portions 21b and 21c, which can extend from the inner panel portion 21, can be respectively formed at upper and lower ends of the inner panel portion 21, such that the upper and lower ends of the inner panel portion 21 can be respectively coupled to the cowl top panel 42 and the guide panel 30.

The outer panel portion 22 can be formed as a surface perpendicular to the width direction of the vehicle and formed in parallel with the inner panel portion 21. The outer panel portion 22 can be disposed outward of the inner panel portion 21 based on the vehicle. The outer panel portion 22 can have upper and lower flange portions 22b and 22c extending from upper and lower ends thereof, such that the upper and lower ends of the outer panel portion 22 can be respectively coupled to the cowl top panel 42 and the cowl lower panel 10.

The inner slot 21a can be formed to be inclined in the inner panel portion 21. That is, referring to FIG. 8A, the inner slot 21a can be formed in the form of a long hole. A central axis of the inner slot 21a can be inclined by an angle α (e.g., selected or predetermined) with respect to an axis perpendicular to the ground surface. Therefore, the inner slot 21a can be formed to be inclined in the inner panel portion 21. The inner slots 21a may be provided as a plurality of inner slots 21a formed in the inner panel portion 21, and the inner slots 21 can be parallel to one another.

The outer slot 22a can be formed to be inclined in the outer panel portion 22. Like the inner slot 21a, the outer slot 22a can be formed in the form of a long hole. Referring to FIG. 8B, a central axis of the outer slot 22a can be inclined by an angle β (e.g., selected or predetermined) with respect to the axis perpendicular to the ground surface. The outer slots 22a may be provided as a plurality of outer slots 22a formed in the outer panel portion 22, and the outer slots 22a can be parallel to one another. However, the outer slot 22a can be formed to be inclined in a direction opposite to the inner slot 21a. Therefore, as illustrated in FIG. 8C, when viewed from a lateral side of the cowl support bracket 20, the inner slot 21a and the outer slot 22a are illustrated as intersecting each other, for example. In this example, when the inner slot 21a and the outer slot 22a are projected onto the same plane, the inner slot 21a and the outer slot 22a may be formed to be almost orthogonal to each other, for example. Because the inner slot 21a and the outer slot 22a can intersect each other and can be formed to be almost orthogonal to each other, the air may easily pass through the cowl support bracket 20 when the air and the moisture pass through the cowl support bracket 20, but the moisture can move downward along the outer panel portion 22 and the inner panel portion 21 and drain to the outside.

The inner panel portion 21 and the outer panel portion 22 can be connected by a connection portion 23. The inner panel portion 21 and the outer panel portion 22 can be connected by the connection portion 23, such that the inner panel portion 21, the outer panel portion 22, and the connection portion 23 are integrated.

A route along which the moisture on the surface of the windshield glass 44 can be moved by the vehicle cowl structure with improved water-tightness according to an embodiment of the present disclosure having the above-mentioned configuration will be described.

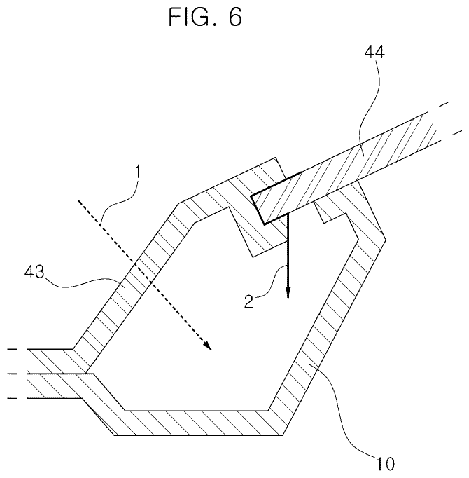

The moisture, which has fallen on or drained to the periphery of the windshield glass 44 of the vehicle during rainfall, a vehicle washing process, or the like, can move to the cowl lower panel 10 through mesh holes formed in the cowl top cover 43, as indicated by the arrow 1 in FIGS. 3 and 6. As indicated by arrows 2 in FIGS. 3 and 6, the moisture, which has moved to the front end of the windshield glass 44 along the surface of the windshield glass 44, can penetrate between the windshield glass 44 and the cowl top cover 43 and move to the cowl lower panel 10.

When the air conditioning device 50 does not operate, the moisture can move outward in the width direction of the vehicle along the cowl lower panel 10 and then is discharged to the outside through the water drain hole 14 (see, e.g., FIG. 5).

However, when the air conditioning device 50 operates, the air can flow to the air conditioning device 50 through the air intake port 31, and the moisture also can move. The air can pass through the cowl support bracket 20 first. Because the outer slot 22a and the inner slot 21a can be formed in the cowl support bracket 20, the air can pass through the cowl support bracket 20. The moisture, which is introduced in the form of mist into the cowl support bracket 20 together with the air, cannot easily pass through the outer slot 22a and the inner slot 21a and can fall onto the cowl lower panel 10 along the surfaces of the outer and inner panel portions 22 and 21.

Even though the moisture is moved along the surface of the cowl lower panel 10 by the operation of the air conditioning device 50, the moisture can be discharged to the lower side of the vehicle without flowing to the air conditioning device 50 through the gap H between the guide panel 30 and the cowl lower panel 10 (see, e.g., FIGS. 5 and 9).

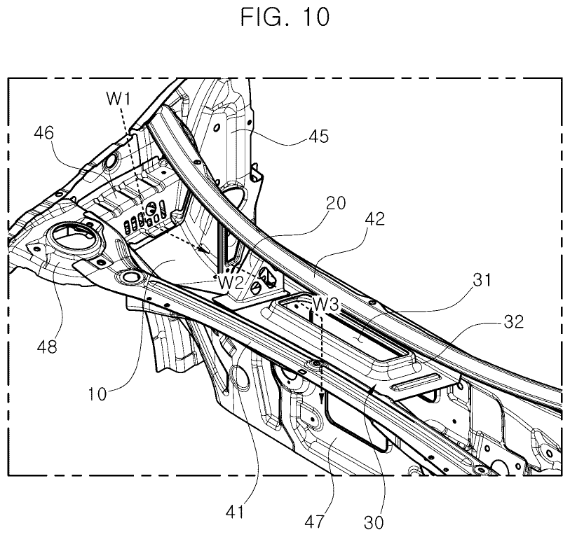

FIG. 10 illustrates a route through which the air introduced through the mesh holes of the cowl top panel 42 can pass. The air can be introduced from the outside into the cowl, i.e., between the cowl top panel 42 and the cowl lower panel 10 through the mesh holes of the cowl top panel 42 (see the arrow W1 in FIG. 10). In this example, most of the moisture can fall onto the cowl lower panel 10 and can be discharged through the water drain hole 14 (see, e.g., FIG. 5). Thereafter, the air can pass through the cowl support bracket 20 (see the arrow W2 in FIG. 10), and a part of the moisture can move to the cowl lower panel 10 along the surface of the cowl support bracket 20 (e.g., when moisture bombards the surface of the cowl support bracket 20 while the moisture passes through the holes 21a and 22a).

The moisture, which flows reversely along the cowl lower panel 10, can be discharged through the gap H between the cowl lower panel 10 and the guide panel 30, and the air, from which the moisture is removed, can be introduced into the air conditioning device 50 through the air intake port 31 (see the arrow W3 in FIG. 10).

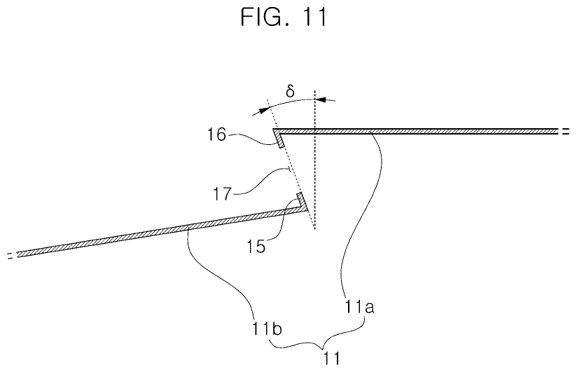

FIG. 11 illustrates a cross-section of the panel portion 11 of a vehicle cowl structure with improved water-tightness according to an embodiment of the present disclosure.

In the example embodiment of FIG. 11, a through-hole 17 can be formed in the panel portion 11 to discharge moisture to the outside when the moisture flows reversely.

The panel portion 11 of the cowl lower panel 10 can be stepped so that an inner side of the vehicle is positioned to be higher in the width direction of the vehicle. That is, in FIG. 11, the right side is the inner side of the vehicle based on the width direction, and the left side is the outer side of the vehicle.

Referring to FIG. 11, a downward bent portion 16, which is bent downward, can be formed at an end of an upper panel portion 11a positioned at an upper side of the panel portion 11, an upward bent portion 15 can be formed at an end of a lower panel portion 11b positioned at a lower side of the panel portion 11, and the through-hole 17 can be formed between the downward bent portion 16 and the upward bent portion 15. In particular, the upward bent portion 15 and the downward bent portion 16 can be inclined by an angle δ (e.g., selected or predetermined) with respect to a line perpendicular to the ground surface.

Therefore, referring to FIG. 11, even though the moisture on the surface of the cowl lower panel 10 can be moved into the vehicle by the operation of the air conditioning device 50 as the air flows, the moisture cannot move primarily by being caught by the upward bent portion 15. Even though the moisture may pass through the upward bent portion 15, the moisture can be discharged to the outside through the through-hole 17. Therefore, using an embodiment of the present disclosure, the moisture can be not introduced into the air conditioning device 50.

In the example embodiment of FIG. 11, because the remaining constituent elements can be identical to those described above relating to FIGS. 3-10, except for the panel portion 11, a detailed description thereof will be omitted.

A number of embodiments have been disclosed herein. It can be understood that various features of the different embodiments can be combined.

What is claimed is:

1. A vehicle cowl structure comprising:
a cowl lower panel extending in a width direction of a vehicle; and
a guide panel having an outer end coupled to an inner end of the cowl lower panel in a configuration so that outside air can be introduced into an air conditioning device of the vehicle therethrough, wherein the outer end of the guide panel is positioned to be higher than the inner end of the cowl lower panel, such that a gap is defined between the inner end of the cowl lower panel and the outer end of the guide panel.

2. The vehicle cowl structure of claim 1, wherein the cowl lower panel and the guide panel overlap each other by a first length in the width direction of the vehicle.

3. The vehicle cowl structure of claim 1, wherein the cowl lower panel comprises:
a panel portion extending in the width direction of the vehicle;
a front flange portion disposed to be higher than the panel portion and at a front end of the panel portion along the panel portion; and
a rear flange portion at a rear end of the panel portion and bent upward from the panel portion.

4. The vehicle cowl structure of claim 3, wherein the panel portion is positioned to be lower than the outer end of the guide panel.

5. The vehicle cowl structure of claim 1, wherein the guide panel comprises:
an air intake port configured for the air introduced from outside to pass therethrough; and
a reverse flow prevention wall having a first height is along a periphery of the air intake port.

6. The vehicle cowl structure of claim 1, further comprising a cowl support bracket having a dual wall structure joined to the cowl lower panel and the guide panel, respectively, wherein the cowl support bracket has slots therein.

7. The vehicle cowl structure of claim 6, wherein the cowl support bracket comprises:
an inner panel portion having an inner slot and having an inner-panel-portion lower end coupled to the guide panel;
an outer panel portion having an outer slot and having an outer-panel-portion lower end coupled to the cowl lower panel; and
a connection portion configured to connect the inner panel portion and the outer panel portion.

8. The vehicle cowl structure of claim 7, wherein the inner slot is inclined in a first direction at a first angle, wherein the outer slot is inclined in a second direction at a second angle, wherein the first direction differs from the second direction.

9. The vehicle cowl structure of claim 8, wherein the inner slot is provided as a plurality of inner slots in the inner panel portion and in parallel with one another, and wherein the outer slot is provided as a plurality of outer slots in the outer panel portion and in parallel with one another.

10. The vehicle cowl structure of claim 7, wherein the cowl support bracket comprises:
an upper flange portion coupled to a cowl top panel at an upper end of the inner panel portion; and
a lower flange portion coupled to the guide panel at a lower end of the inner panel portion.

11. The vehicle cowl structure of claim 7, wherein the cowl support bracket comprises:
an upper flange portion coupled to a cowl top panel at an upper end of the outer panel portion; and
a lower flange portion coupled to the cowl lower panel at a lower end of the outer panel portion.

12. The vehicle cowl structure of claim 1, wherein a panel portion of the cowl lower panel is stepped so that the panel portion on an inner side of the vehicle is configured to be higher than the panel portion on an outer side of the vehicle in the width direction of the vehicle.

13. The vehicle cowl structure of claim 12, wherein the cowl lower panel comprises:
a downward bent portion bent downward at a first end of an upper panel portion positioned at an upper side of the panel portion;
an upward bent portion at a second end of a lower panel portion positioned at a lower side of the panel portion; and
a through-hole between the downward bent portion and the upward bent portion.

14. The vehicle cowl structure of claim 13, wherein the upward bent portion and the downward bent portion are inclined by an angle with respect to a line perpendicular to a ground surface.

15. A vehicle cowl structure comprising:
a cowl lower panel extending in a width direction of a vehicle; and
a guide panel having a raised air intake port, wherein the guide panel has an outer end coupled to an inner end of the cowl lower panel, wherein the outer end of the guide panel is higher than the inner end of the cowl lower panel, such that a gap is defined between the inner end of the cowl lower panel and the outer end of the guide panel, wherein the guide panel overlaps the cowl lower panel by a first length in the width direction of the vehicle over the gap.

16. The vehicle cowl structure of claim 15, further comprising a cowl support bracket connected to the cowl lower panel and the guide panel along an airflow path, wherein the guide panel is coupled to the cowl lower panel via the cowl support bracket.

17. The vehicle cowl structure of claim 16, wherein the cowl support bracket comprises:
an inner panel portion having an inner air slot and having an inner-panel-portion lower end coupled to the guide panel; and
an outer panel portion having an outer air slot and having an outer-panel-portion lower end coupled to the cowl lower panel.

18. The vehicle cowl structure of claim 17, wherein the inner air slot is inclined in a first direction at a first angle, wherein the outer air slot is inclined in a second direction at a second angle, wherein the first direction differs from the second direction.

19. The vehicle cowl structure of claim 17, wherein the cowl support bracket comprises:
an upper inner-panel-portion flange at an upper inner-panel-portion end of the inner panel portion, wherein the upper inner-panel-portion flange is coupled to a cowl top panel;
a lower inner-panel-portion flange at a lower inner-panel-portion end of the inner panel portion, wherein the lower inner-panel-portion flange is coupled to the guide panel;
an upper outer-panel-portion flange at an upper outer-panel-portion end of the outer panel portion, wherein is the upper outer-panel-portion flange coupled to the cowl top panel; and
a lower outer-panel-portion flange at a lower outer-panel-portion end of the outer panel portion, wherein the lower outer-panel-portion flange is coupled to the cowl lower panel.

20. A vehicle cowl structure comprising:
a cowl lower panel extending in a width direction of a vehicle; and
a guide panel having a raised air intake port; and
a cowl support bracket having air flow slots therein, the cowl support bracket being connected to an inner end of the cowl lower panel, and the cowl support bracket being connected to an outer end of the guide panel, wherein the outer end of the guide panel is higher than the inner end of the cowl lower panel, such that a gap is defined between the inner end of the cowl lower panel and the outer end of the guide panel, wherein the guide panel overlaps the cowl lower panel by a first length over the gap.
